(19) United States
(12) Patent Application Publication
(10) Pub. No.: US 2017/0348698 A1
(43) Pub. Date: Dec. 7, 2017

(54) MODULAR SYSTEM FOR PERFORMING A PLURALITY OF CRUSHING AND GRINDING PROCESSES

(71) Applicant: FREWITT FABRIQUE DE MACHINES SA, Granges-Paccot (CH)

(72) Inventors: Antoine VIRDIS, Ferpicloz (CH); Christophe PASQUIER, Romanens (CH)

(21) Appl. No.: 15/536,230

(22) PCT Filed: Dec. 16, 2015
(86) PCT No.: PCT/IB2015/059677

§ 371 Date: Jun. 15, 2017

(30) Foreign Application Priority Data
Dec. 17, 2014 (EP) 14198639.8

(51) Int. Cl. B02C 19/00; B02C 13/286; B02C 18/24; B02C 18/18

(52) U.S. Cl. CPC B02C 19/0056; B02C 18/24; B02C 13/286; B02C 18/184

(57) ABSTRACT

A modular system for performing a plurality of crushing and grinding processes, including: a plurality of interchangeable milling heads, each interchangeable milling head having a milling mechanism configured to perform one of the plurality of crushing and grinding processes when driven; a driving unit including a driving motor having a range of motor characteristics; and a connecting unit configured to functionally connect one of the interchangeable milling heads to the driving motor such that, when connected, the one of the plurality of interchangeable milling heads can perform the one of the plurality of crushing and grinding processes. Each of the plurality of interchangeable milling heads further includes an adaptor unit configured to connect the milling head to the connecting unit and for converting the range of motor characteristics of the driving motor into the milling driving characteristics of the connected interchangeable milling heads.

### FIELD

The present invention concerns a modular system for performing a plurality of crushing and grinding processes comprising a plurality of interchangeable milling heads.

### DESCRIPTION OF RELATED ART

Modular systems for performing milling process comprising a plurality of milling heads are already known. For example, a device for bone crushing having a plurality of heads in order to obtain various sized bone powder as well as to facilitate the sterilization of the crushing heads is known from document U.S. Pat. No. 5,918,821.

Document DE19723705 discloses a crushing mill whose crushing head is interchangeable to provide optimized granularity. A crushing mill comprising interchangeable hummer crushing heads is also described in DE102006018165. Document GB758813 discloses a mill comprising a plurality of milling disks providing hummer and conical crushing.

Such modular systems for performing milling process are limited in the selection of milling heads and do not provide more that a single milling process. The driving motors used in the known systems have a range of characteristics that does allow only for a limited type of milling heads and milling processes.

### SUMMARY

The present disclosure concerns a modular system for performing a plurality of crushing and grinding processes, comprising: a plurality of interchangeable milling heads, each interchangeable milling head comprising a milling mechanism configured to perform one of said plurality of crushing and grinding processes when driven; a driving unit comprising a driving motor having a range of motor characteristics; and a connecting unit configured to functionally connect one of the interchangeable milling heads to the driving motor such that, when connected, said one of the plurality of interchangeable milling heads can perform said one of said plurality of crushing and grinding processes; each of said plurality of interchangeable milling heads further comprises an adaptor unit configured to connect the milling head to the connecting unit and for converting the range of motor characteristics of the driving motor into the milling driving characteristics of the connected interchangeable milling heads.

The plurality of interchangeable milling heads can include at least one of: a conical sieve milling head, a cylindrical sieve milling head, a hammer milling head, an oscillating and rotating sieve milling head, a desagglomeration milling head, a sifting milling head.

### BRIEF DESCRIPTION OF THE DRAWINGS

The invention will be better understood with the aid of the description of an embodiment given by way of example and illustrated by the figures, in which:

FIG. 1 shows a view of a modular system for performing a plurality of crushing and grinding processes, according to the invention;

FIG. 2 show a view of the modular system of FIG. 1 connecting one of the plurality of milling heads, according to the invention; and

FIGS. 3 to 7 illustrate some details of the connecting unit and of the milling head of the modular system, according to the invention.

### DETAILED DESCRIPTION OF POSSIBLE EMBODIMENTS

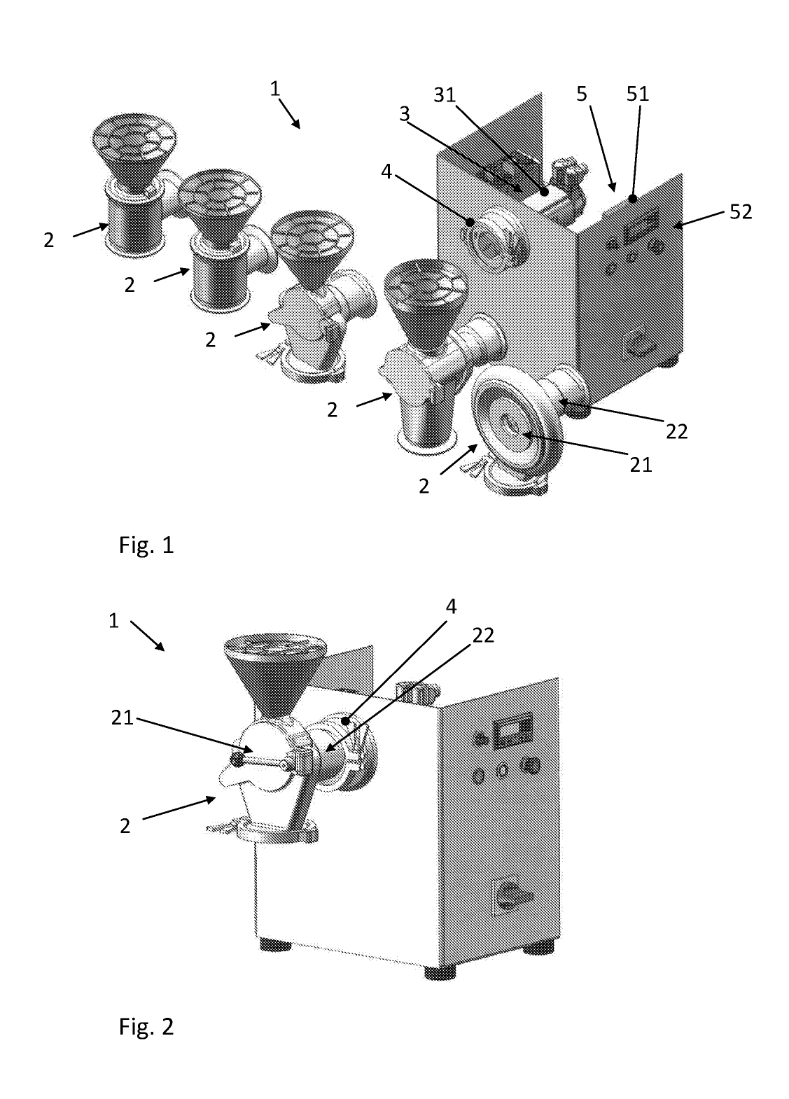

FIGS. 1 and 2 show a modular system 1 for performing a plurality of crushing and grinding processes. The modular system 1 comprises a plurality of interchangeable milling heads 2 (see FIG. 2) to be functionally connected to a driving unit 3. Each interchangeable milling head 2 comprises a milling mechanism 21 configured to perform one of said plurality of crushing and grinding processes when driven by the driving unit 3.

The driving unit 3 comprises a driving motor 31 destined to provide a predefined range of motor characteristics. Preferably, the motor 31 is an electrical motor such as a high-speed brushed electrical motor or a servomotor. Advantageously, a servomotor can provide the required predefined range of motor characteristics while limiting the cost of the modular system. The motor characteristics can comprise any characteristics of the driving motor 31 that are suitable for driving any of the plurality of interchangeable milling heads 2 for performing any of the plurality of crushing and grinding processes. For example, motor characteristics can comprise a range of torque, power, rotational speed, oscillating movement, etc.

Each of the interchangeable milling heads 2 can be functionally connected to the driving unit 3 with a connecting unit 4. In particular, the connecting unit 4 is configured to functionally connect one of the interchangeable milling heads 2 to the driving motor 31 such that, when connected, said one of the plurality of interchangeable milling heads 2 can perform said one of said plurality of crushing and grinding processes.

Each of the plurality of interchangeable milling heads 2 further comprises an adaptor unit 22 configured to connect the milling head 2 to the connecting unit 4. The adaptor unit 22 is further configured for converting the range of motor characteristics of the driving motor 31 into the milling driving characteristics of the connected interchangeable milling heads 2.

Example of possible interchangeable milling heads 2 can include a conical sieve milling head, a cylindrical sieve milling head, a hammer milling head, an oscillating and rotating sieve milling head, a desagglomeration milling head, a sifting milling head, or any other suitable milling head.

In an embodiment, the adaptor unit 22 comprises a gear set (not shown) configured for converting the range of motor characteristics of the driving motor 31 into the milling driving characteristics of said milling mechanism 21. The adaptor unit 22 comprising the gear set is thus capable, after connecting the milling head 2 to the connecting unit 4, of converting the range of motor characteristics of the driving motor 31 into the milling driving characteristics corresponding to the specific milling head 2 such that the milling head 2 can perform the specific process.

For example, the adaptor unit 22 comprising the gear set can be arranged for reducing or increasing a rotational angular speed, depending on the milling head 2 connected to the driving motor 31 via the connecting unit 4.

For example, the adaptor unit 22 comprising the gear set can convert the motor characteristics into rotational angular speed between 1000 rpm and 20000 rpm, or between 100 rpm and 1000 rpm. Here, rpm means rotations per minute, i.e., 1 rpm=6 rad·s⁻¹.

For example, the adaptor unit 22 comprising the gear set can convert the motor characteristics such as to increase or reduce the torque, such as to obtain torque values suitable for the milling head 2 being connected to the driving motor 31.

For example, the driving motor 31 can have motor characteristics such as to provide a rotational torque having a magnitude in a range from 0.2 Nm to 20 Nm (where Nm means newton metre). Such range can be suitable for driving a large selection of milling heads 2.

Referring to FIG. 1, the driving motor 31 is arranged in a casing 50 comprising the connecting unit 4.

In an embodiment, the modular system 1 is arranged for providing an electrical and/or communication signal and/or an electrical power supply signal to the milling head 2. The modular system 1 can be further arranged to collect a communication or electrical signal from the milling head 2. To that end, an electrical module 5 can be included in the casing 50. The electrical power supply signal and the communication or electrical signals to and/or from the milling head 2 can be provided by the electrical module 5, via the connecting unit 4. The electrical or communication signal can be used for communicating with probes, sensors or actuators (not shown) comprised in the milling head 2.

In an embodiment, the modular system 1 comprises a control unit 51 that can be used for controlling a milling process in accordance with the milling head 2 being connected to the driving motor 31. The modular system 1 can further comprise a user interface allowing a user to interact with the control unit 51. The control unit 51 can comprise a PC or a PC-like motherboard, a customized electronically circuit provided with a programmable circuit or device, like a microprocessor, a DSP or a microcontroller.

The adaptor unit 22 comprises a gear set, in combination with the connecting unit 4, is thus arranged to provide the mechanical movement as well as electrical or communication signals required by the milling head 2 being connected to the driving motor 31, when the milling head 2 is driven. No additional cable needs to be connected between the milling head 2 and the electrical module 5 of the modular system 1.

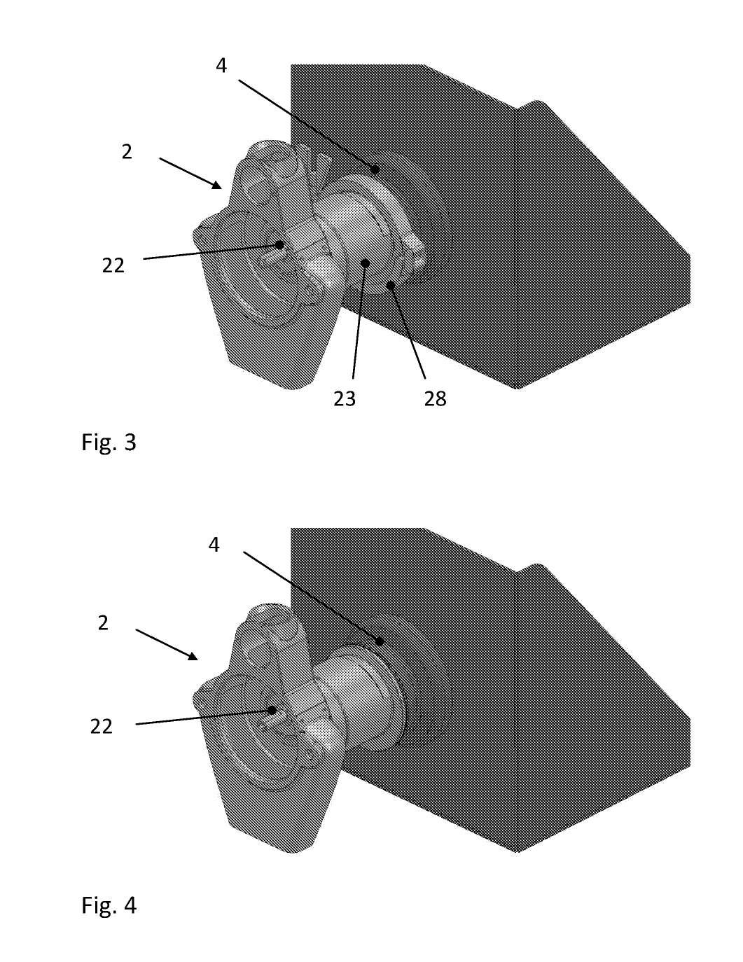

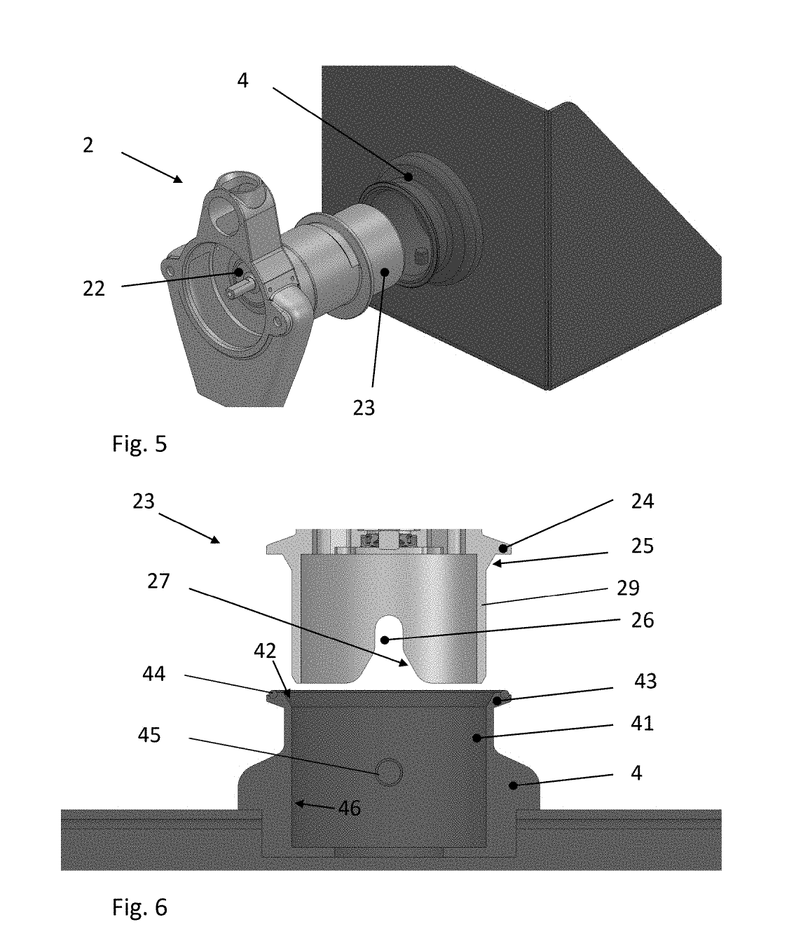

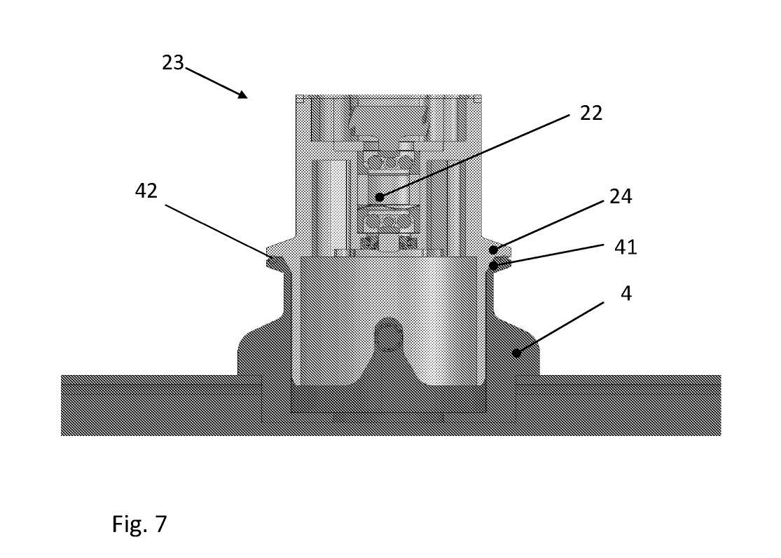

FIGS. 3 to 7 show details of the connecting unit 4 of the driving unit 3 and of a connector 23 of one of the milling heads 2.

FIG. 6 shows a cross section view of the connecting unit 4 and the connector 23, according to an embodiment. The connector 23 comprises an engaging portion 29 that can be driven in a receiving portion 41 of the connecting unit 4 when the milling head 2 is functionally connected to the driving unit 3. The engaging portion 29 and the receiving portion 41 guide the milling head 2 angularly and axially with respect to the connecting unit 4.

In the particular example of FIG. 6, both the engaging portion 29 and the receiving portion 41 are tube-shaped, with engaging portion 29 having an outer diameter fitting in the internal diameter of the receiving portion 41.

An internal wall 46 of the receiving portion 41 comprises a bevel edge 42 in order to guide and center radially the engaging portion 29 when the engaging portion 29 is engaged in the receiving portion 41. The receiving portion 41 can further comprise a pin 45, located on its internal wall 46. The pin 45 is arranged to cooperate with a groove 26 provided in the engaging portion 29 such as to guide the engaging portion 29 angularly with respect to the receiving portion 41, when the engaging portion 29 is engaged in the receiving portion 41. The groove 26 can comprise a tapered opening 27 for guiding the pin 45 angularly within the groove 26 when the engaging portion 29 is inserted in the receiving portion 41.

The connector 23 can include a flange 24 configured to be used as an axial abutment such that the engaging portion 29 cannot be inserted too far into the receiving portion 41. The flange 24 can include a bevel edge 25 conforming the bevel edge 42, such as to increase the contact surface between the engaging portion 29 and the receiving portion 41.

When the engaging portion 29 is inserted in the receiving portion 41, the flange 24 of the engaging portion 29 and a flange 43 of the receiving portion 41 can be attached by using a ring latch 28 (see FIG. 3), or any other suitable fixation means.

An O-ring 44 can be comprised between the flange 24 of the engaging portion 29 and the flange 43 of the receiving portion 41 such as to provide airtightness between the connecting unit 4 and the interchangeable milling head 2.

The gear set (not shown) can be located inside the connector 23 of the interchangeable milling head 2. Advantageously, the entire adaptor unit 22 is located inside the housing of the connector 23 of the interchangeable milling head 2.

The modular system 1 can be destined to laboratories as well as for production where there is a need combine the flexibility of having a large selection of milling processes in a limited room space.

### LIST OF ELEMENTS USED IN DRAWINGS

1 modular system
2 interchangeable milling head
21 milling mechanism
22 adaptor unit
23 connector
24 flange
25 bevel edge
26 groove
27 tapered opening
28 ring latch
29 engaging portion
3 driving unit
31 motor
4 connecting unit
41 receiving portion
42 bevel edge
43 flange
44 O-ring
45 pin
46 internal wall
5 electrical module
50 casing
51 control unit
52 interface

What is claimed is:

1. A modular system for performing a plurality of crushing and grinding processes, comprising:
a plurality of interchangeable milling heads, each interchangeable milling head comprising a milling mechanism configured to perform one of said plurality of crushing and grinding processes when driven;
a driving unit comprising a driving motor having a range of motor characteristics; and
a connecting unit configured to functionally connect one of the interchangeable milling heads to the driving motor such that, when connected, said one of the plurality of interchangeable milling heads can perform said one of said plurality of crushing and grinding processes;
wherein each of said plurality of interchangeable milling heads further comprises an adaptor unit configured to connect the milling head to the connecting unit and for converting the range of motor characteristics of the driving motor into the milling driving characteristics of the connected interchangeable milling heads.

2. The modular system according to claim 1, wherein the adaptor unit comprises a gear set configured for converting the range of motor characteristics of the driving motor into the milling driving characteristics of said milling mechanism.

3. The modular system according to claim 1,
wherein the milling head comprises a connector including an engaging portion that can be driven in a receiving portion of the connecting unit when the milling head is connected to the driving unit;
the engaging portion and the receiving portion guiding the milling head angularly and axially with respect to the connecting unit.

4. The modular system according to claim 3, wherein the engaging portion and the receiving portion are tube-shaped

5. The modular system according to claim 3 4,
wherein the receiving portion comprises a bevel edge for guiding and centering radially the engaging portion when the latter is engaged in the receiving portion.

6. The modular system according to claim 5, wherein the receiving portion further comprises a pin arranged for cooperating with a groove provided in the engaging portion, such as to guide the engaging portion angularly with respect to the receiving portion when the engaging portion is engaged in the receiving portion.

7. The modular system according to claim 6, wherein the groove further comprises a tapered opening for guiding the pin angularly within the groove when the engaging portion is inserted in the receiving portion.

8. (canceled)

9. The modular system according to claim 7,
wherein the adaptor unit comprises a gear set configured for converting the range of motor characteristics of the driving motor into the milling driving characteristics of said milling mechanism.

10. The modular system according to claim 9, wherein the adaptor unit comprising the gear set is arranged for reducing or increasing a rotational angular speed, depending on the milling head connected to the driving motor.

11. The modular system according to claim 1,
further comprising an electrical module for providing an electrical or communication signal or an electrical signal to and/or from the milling head.

12. The modular system according to claim 1,
further comprising a control unit for controlling a milling process in accordance with the milling head being connected to the driving motor.

13. The modular system according to claim 12, further comprising a user interface allowing a user to interact with the control unit.

14. The modular system according to claim 1,
wherein said plurality of interchangeable milling heads includes at least one of: a conical sieve milling head, a cylindrical sieve milling head, a hammer milling head, an oscillating and rotating sieve milling head, a desagglomeration milling head, a sifting milling head.
